(19) United States
(12) Patent Application Publication
(10) Pub. No.: US 2026/0003448 A1
(43) Pub. Date: Jan. 1, 2026

(54) ELECTRONIC DEVICE AND SMART CONTROL METHOD THEREOF

(71) Applicant: Acer Incorporated, New Taipei City (TW)

(72) Inventor: Pe-Yi LIN, New Taipei City (TW)

(73) Assignee: Acer Incorporated, New Taipei City (TW)

(21) Appl. No.: 19/208,307

(22) Filed: May 14, 2025

(30) Foreign Application Priority Data
Jun. 26, 2024 (TW) 113123740

(51) Int. Cl. G06F 3/038; A63F 13/40; G06F 3/023; G06F 3/0354

(52) U.S. Cl. CPC G06F 3/038; A63F 13/40; G06F 3/023; G06F 3/03541; G06F 3/03547

(57) ABSTRACT

An electronic device and a smart control method thereof are provided. The electronic device includes an application management unit, an interception unit, an identification model, and a control unit. The application management unit is used to detect an application being executed by the electronic device. The interception unit is used to continuously intercept at least one input unit during a detection period to obtain a plurality of input signals and a plurality of time information corresponding to the input signals. The identification model is used to receive the application, the input signals, and the time information corresponding to the input signals to output an operating status of the application. The operating status includes a busyness level. The control unit is used to control at least one hardware parameter of the electronic device according to the application and the operating status thereof.

This application claims the benefit of Taiwan application Serial No. 113123740, filed Jun. 26, 2024, the subject matter of which is incorporated herein by reference.

### BACKGROUND OF THE INVENTION

### Field of the Invention

The invention relates in general to an electronic device and a control method thereof, and more particularly to an electronic device and a smart control method thereof.

### Description of the Related Art

Nowadays, computers have become an indispensable necessity to many families. People can use computers to execute different applications with which they can prepare reports, play games, browse webpages, or watch videos.

When a computer operates different applications, the computer may be in different operating status, such as busy, idle, or other status. If the computer adopts the same hardware setting regardless of the applications being executed and the operating status, the computer will not produce best hardware efficiency and best power saving effect.

### SUMMARY OF THE INVENTION

The invention is directed to an electronic device and a smart control method thereof. The operating status of the applications are detected using AI technology, and hardware parameters of the electronic device are dynamically adjusted, so that the electronic device can produce best hardware efficiency and achieve best power saving effect.

According to one embodiment of the present invention, a smart control method for an electronic device is provided. The smart control method for an electronic device includes the following steps: detecting an application being executed by the electronic device; continuously intercepting at least one input unit during a detection period to obtain a plurality of input signals and a plurality of time information corresponding to the input signals; inputting the application, the input signals, and the time information corresponding to the input signals to an identification model to output an operating status of the application, wherein the operating status comprises a busyness level; and controlling the at least one hardware parameter of the electronic device according to the application and the operating status thereof.

According to another embodiment of the present invention, an electronic device is provided. The electronic device includes an application management unit, an interception unit, an identification model, and a control unit. The application management unit is used to detect an application being executed by the electronic device. The interception unit is used to continuously intercept at least one input unit during a detection period to obtain a plurality of input signals and a plurality of time information corresponding to the input signals. The identification model is used to receive the application, the input signals, and the time information corresponding to the input signals to output an operating status of the application. The operating status includes a busyness level. The control unit is used to control at least one hardware parameter of the electronic device according to the application and the operating status thereof.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A illustrates a “busy” operating status of an electronic device executing a “gaming” application.

FIG. 1B illustrates an “idle” operating status of an electronic device executing a “gaming” application.

FIG. 2A illustrates a “busy” operating status of an electronic device executing a “web page browsing” application.

FIG. 2B illustrates an “idle” operating status of an electronic device executing a “web page browsing” application.

FIG. 3 is a block diagram of an electronic device according to an embodiment of the present disclosure.

FIG. 4 is a flowchart of a smart control method for an electronic device according to an embodiment of the present disclosure.

FIG. 5 is a schematic diagram of an identification model of an electronic device according to an embodiment of the present disclosure.

FIG. 6 illustrates different operating status obtained by detecting a “keyboard” input unit.

FIG. 7 illustrates different operating status obtained by detecting a “mouse” input unit.

FIG. 8 illustrates different operating status obtained by detecting a “touch pad” input unit.

### DETAILED DESCRIPTION OF THE INVENTION

Technical terms are used in the specification with reference to the prior art used in the technology field. For any terms described or defined in the specification, the descriptions and definitions in the specification shall prevail. Each embodiment of the present disclosure has one or more technical features. Given that each embodiment is implementable, a person ordinarily skilled in the art can selectively implement or combine some or all of the technical features of any embodiment of the present disclosure.

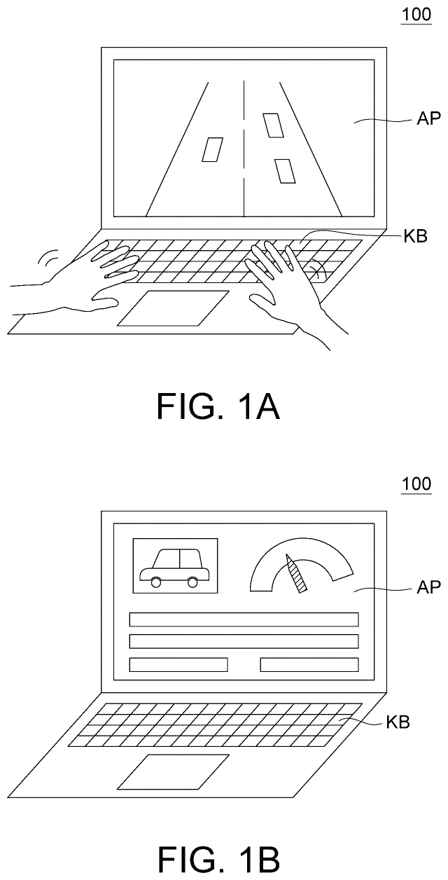

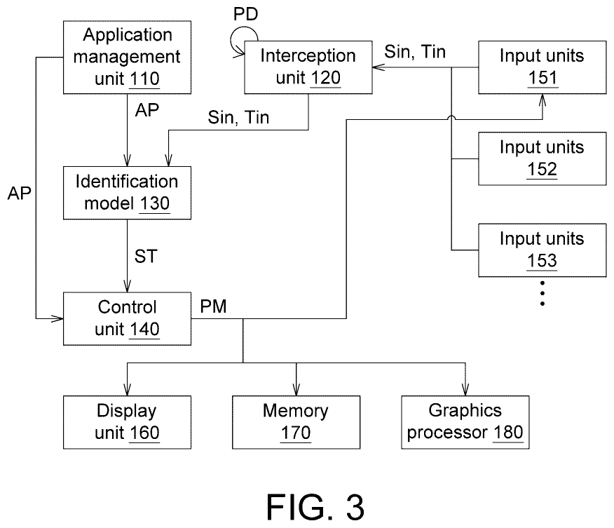

Referring to FIG. 1A, a “busy” operating status ST of an electronic device 100 executing a “gaming” application AP is illustrated (FIG. 3). In an embodiment, when the user uses the electronic device 100 to execute a “gaming” application AP, the user, during the game, may quickly and extensively use the keyboard KB to control and operate the game; meanwhile, the electronic device 100 is in a “busy” operating status ST. After recognizing the application AP and the “busy” operating status ST, the present technology automatically increases the operating frequency of the processor, the resource allocation of the memory, or the frame refresh rate, so that the electronic device 100 can produce best hardware efficiency and provide better user experience.

Referring to FIG. 1B, an “idle” operating status ST of an electronic device 100 executing a “gaming” application AP is illustrated (FIG. 3). In another embodiment, when the user uses the electronic device 100 to execute a “gaming” application AP, the user, during the game, may need to check the setting of the game or perform equipment trading, and therefore will not extensively use the keyboard KB to control and operate the game; meanwhile, the electronic device 100 is in an “available” operating status ST. After recognizing the application AP and the “available” operating status ST, the present technology will automatically reduce the operating frequency of the processor, the resource allocation of the memory, or the frame refresh rate, so that the electronic device 100 can achieve best power saving effect and provide better user experience.

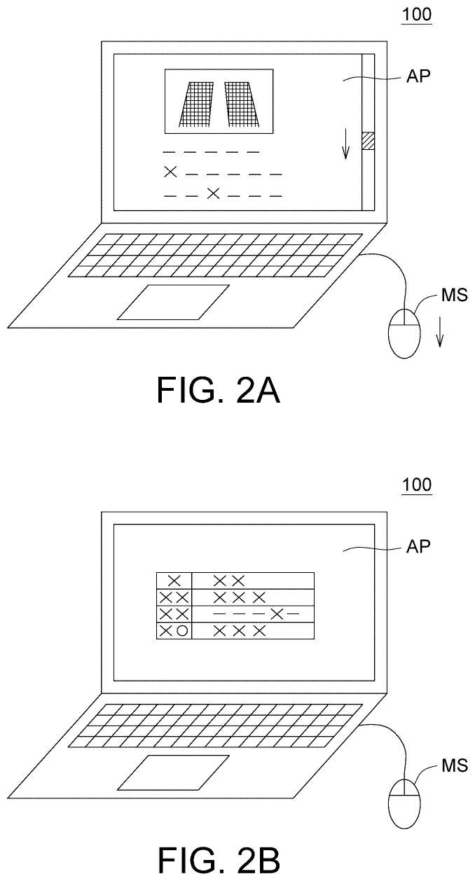

Referring to FIG. 2A, a “busy” operating status ST of an electronic device 100 executing a “web page browsing” application AP is illustrated (FIG. 3). In an embodiment, when the user uses the electronic device 100 to execute a “web page browsing” application AP, the user, during the browsing process, may quickly and extensively use the mouse MS to control webpages; meanwhile, the electronic device 100 is in a “busy” operating status ST. After recognizing the application AP and a “busy” operating status ST, automatically increase the operating frequency of the processor, the resource allocation of the memory, or the frame refresh rate, so that the electronic device 100 can produce best hardware efficiency and provide better user experience.

Referring to FIG. 2B, an “idle” operating status ST of an electronic device 100 executing a “web page browsing” application AP is illustrated (FIG. 3). In another embodiment, when the user uses the electronic device 100 to execute a “web page browsing” application AP, the user, during the browsing process, may need to carefully check a particular table or article, and therefore will not extensively use the mouse MS to control and operate webpages; meanwhile, the electronic device 100 is in an “available” operating status ST. After recognizing the application AP and the “available” operating status ST, the present technology will automatically reduce the operating frequency of the processor, the resource allocation of the memory, or the frame refresh rate, so that the electronic device 100 can achieve best power saving effect and provide better user experience.

Referring to FIG. 3, a block diagram of an electronic device 100 according to an embodiment of the present disclosure is shown. The electronic device 100 includes an application management unit 110, an interception unit 120, an identification model 130, a control unit 140, at least one input units 151, 152, 153, . . . , a display unit 160, a memory 170 and a graphics processor 180. The application management unit 110 is used to manage the application AP. The interception unit 120 is used to intercept the input units 151, 152, 153, The identification model 130 is used to perform an AI recognition procedure. The control unit 140 is used to execute a control procedure. The input units 151, 152, 153 can be realized by such as a keyboard, a mouse, and a touch pad, respectively. The input unit can be a stylus or touch screen. The display unit 160, such as an LCD or OLED panel, is used to display frame or information.

The application management unit 110, the interception unit 120, the identification model 130, the control unit 140 and/or the graphics processor 180 can be realized by such as a circuit, a circuit board, a storage device that stores program code or a chip. The chip can be realized by such as a central processing unit (CPU), or other programmable general-purpose or special-purpose micro control unit (MCU), a microprocessor, digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA) or other similar elements or a combination of the above elements.

In the present embodiment, the operating status ST of the application AP is detected using AI technology and hardware parameters of the electronic device 100 are dynamically adjusted, so that the electronic device 100 can produce best hardware efficiency and achieve best power saving effect. Detailed descriptions of the above elements are provided below with an accompanying flowchart.

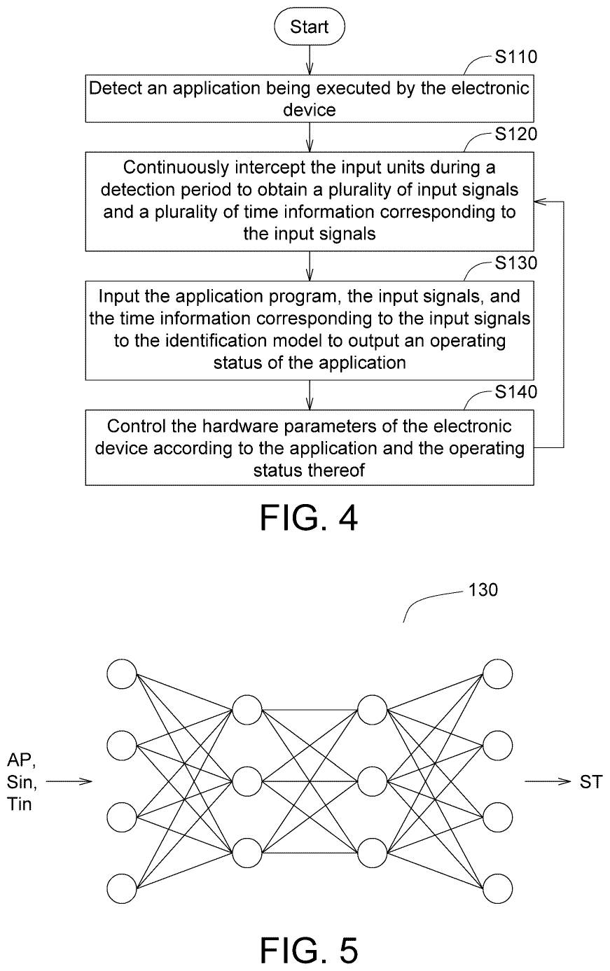

Refer to FIG. 3 and FIG. 4. FIG. 4 is a flowchart of a smart control method for an electronic device 100 according to an embodiment of the present disclosure. The smart control method for an electronic device 100 includes steps S110 to S140.

In step S110, as indicated in FIG. 3, an application AP being executed by the electronic device 100 is detected by the application management unit 110. The application AP can be a “gaming”, “web page browsing” or “video editing” application.

Next, the method proceeds to step S120, as indicated in FIG. 3, the input units 151, 152, 153, . . . are continuously intercepted by the interception unit 120 during the detection period PD to obtain a plurality of input signals Sin and a plurality of time information Tin corresponding to the input signals Sin.

Referring to FIG. 5, a schematic diagram of an identification model 130 of an electronic device 100 according to an embodiment of the present disclosure is shown. In step S130, the application AP, the input signals Sin, and the time information Tin corresponding to the input signals Sin are inputted to the identification model 130 by the interception unit 120 to output an operating status ST of the application AP. The operating status ST includes a busyness level, such as “busy” or “idle”.

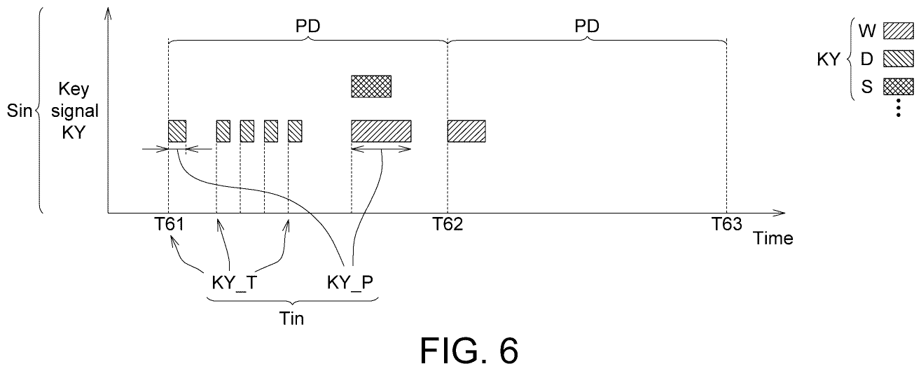

Referring to FIG. 6, different operating status ST obtained by detecting a “keyboard” input unit 151 are illustrated. In the embodiment as indicated in FIG. 6, the input signal Sin may include key signals KY corresponding to the keys W, D, S; the time information Tin may include the trigger time point KY_T and the press duration KY_P corresponding to each key signal KY.

As indicated FIG. 6, during the detection period PD of time points T61 to T62, the interception unit 120 detects several items of key signals KY and the time information Tin corresponding to the key signals KY. The application AP being executed, the input signals Sin, and the time information Tin are all inputted to the identification model 130 to output an operating status ST of the application AP. For instance, a “busy” operating status ST is recognized during the detection period PD of time points T61 to T62.

As indicated FIG. 6, during the detection period PD of time points T62 to T63, the interception unit 120 only intercepts an item of key signal KY and the time information Tin corresponding to the key signal KY. The application AP being executed, the input signals Sin, and the time information Tin are all inputted to the identification model 130 to output an operating status ST of the application AP. For instance, an “idle” operating status ST is recognized during the detection period PD of time points T62 to T63.

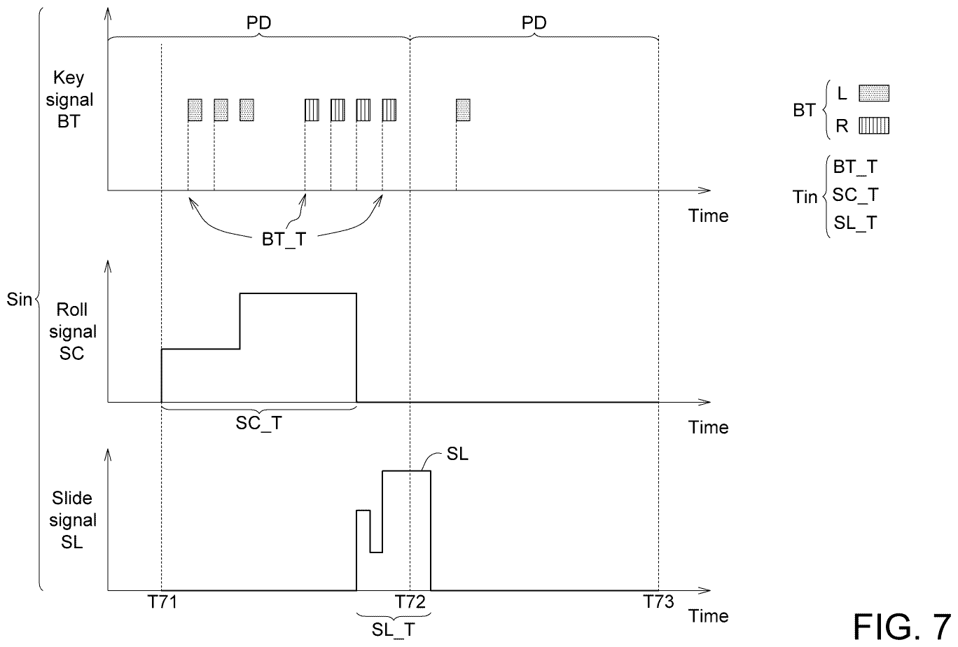

Referring to FIG. 7, different operating status ST obtained by detecting a “mouse” input unit 152 are illustrated. In the embodiment as indicated in FIG. 7, the input signal Sin may include a key signal BT corresponding to a left key L and a right key R, a roll signal SC of the roller, and a slide signal SL of the mouse; the time information Tin may include a trigger time point BT_T corresponding to each key signal BT, a roll time SC_T corresponding to the roll signal SC, and a slide time SL_T corresponding to the slide signal SL.

As indicated FIG. 7, during the detection period PD of time points T71 to T72, the interception unit 120 detects several items of key signals BT and the time information Tin corresponding to the key signals BT. The application AP being executed, the input signals Sin, and the time information Tin all are inputted to the identification model 130 to output an operating status ST of the application AP. For instance, a “busy” operating status ST is recognized during the detection period PD of time points T71 to T72.

As indicated FIG. 7, during the detection period PD of time points T72 to T73, the interception unit 120 only detects an item of key signal BT, a transient slide signal SL, and the time information Tin corresponding to the transient slide signal SL. The application AP being executed, the input signals Sin, and the time information Tin all are inputted to the identification model 130 to output an operating status ST of the application AP. For instance, an “idle” operating status ST is recognized during the detection period PD of time points T72 to T73.

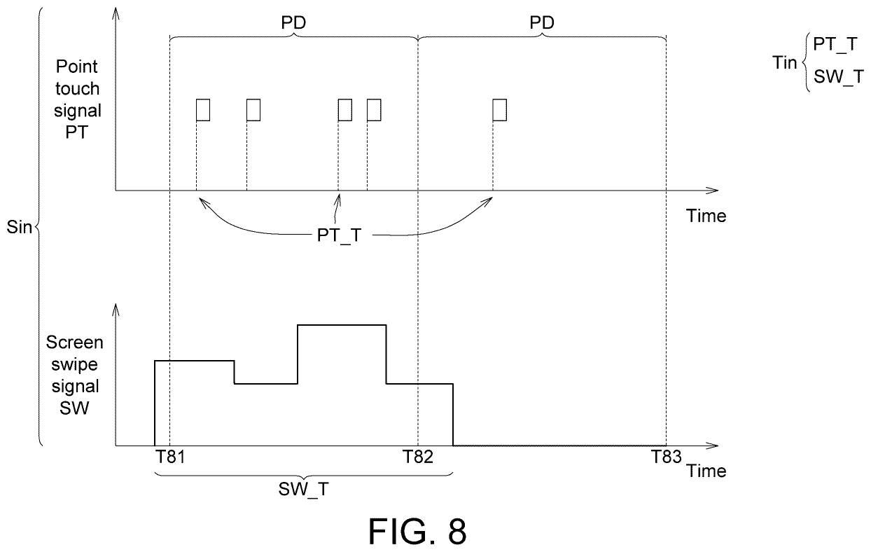

Referring to FIG. 8, different operating status ST obtained by detecting a “touch pad” input unit 153 are illustrated. In the embodiment as indicated in FIG. 8, the input signal Sin may include a point touch signal PT and a screen swipe signal SW; the time information Tin may include a trigger time point PT_T corresponding to each point touch signal PT, and a screen swipe time SW_T corresponding to the screen swipe signal SW.

As indicated FIG. 8, during the detection period PD of time points T81 to T82, the interception unit 120 detects several items of point touch signals PT and the time information Tin corresponding to point touch signals PT. The application AP being executed, the input signals Sin, and the time information Tin all are inputted to the identification model 130 to output an operating status ST of the application AP. For instance, a “busy” operating status ST is recognized during the detection period PD of time points T81 to T82.

As indicated FIG. 8, during the detection period PD of time points T82 to T83, the interception unit 120 only detects an item of point touch signal PT, a transient screen swipe signal SW, and the time information Tin corresponding to the transient screen swipe signal SW. The application AP being executed, the input signals Sin, and the time information Tin all are inputted to the identification model 130 to output an operating status ST of the application AP. For instance, an “idle” operating status ST is recognized during the detection period PD of time points T82 to T83.

Next, the method proceeds to step S140, the control unit 140 controls at least one hardware parameter PM of the electronic device 100 according to the application AP and an operating status ST of the application AP. For instance, the control unit 140 controls the frame refresh rate of the display unit 160 or allocates the resource of the memory 170 or the resource of the graphics processor 180 according to the application AP and the operating status ST to effectively use the resources and reduce power consumption.

After recognizing the application AP and “busy” or an “idle” operating status ST using the smart control method for the electronic device 100, the present technology automatically adjusts the operating frequency of the processor, the resource allocation of the memory, or the frame refresh rate, so that the electronic device 100 can produce best hardware efficiency and achieve best power saving effect and provide better user experience.

Distinctive features of some implementations or examples for implementing the present disclosure are disclosed above. Specific examples (such as numerals or designations disclosed above) are used in the descriptions of elements and configurations to simplify/illustrate some implementations of the present disclosure. These elements and configurations are exemplified for explanatory purpose only, not for limiting the scope of protection. Besides, some implementations of the present disclosure can repeat reference symbols and/or letters in various examples. The said repetition is for the purpose of simplicity and clarity only, not for specifying the relationship among various implementations and/or configurations.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A smart control method for an electronic device, comprising:
detecting an application being executed by the electronic device;
continuously intercepting at least one input unit during a detection period to obtain a plurality of input signals and a plurality of time information corresponding to the input signals;
inputting the application, the input signals, and the time information corresponding to the input signals to an identification model to output an operating status of the application, wherein the operating status comprises a busyness level; and
controlling at least one hardware parameter of the electronic device according to the application and the operating status thereof.

2. The smart control method for an electronic device according to claim 1, wherein the at least one input unit is a keyboard, and the input signals comprise a plurality of key signals.

3. The smart control method for an electronic device according to claim 2, wherein each of the time information comprises a trigger time point corresponding to one of the key signals.

4. The smart control method for an electronic device according to claim 2, wherein each of the time information comprises a press duration corresponding to one of the key signals.

5. The smart control method for an electronic device according to claim 1, wherein the at least one input unit is a mouse, and the input signals comprise a plurality of key signals, a plurality of roll signals, and a plurality of slide signals.

6. The smart control method for an electronic device according to claim 5, wherein each of the time information comprises a trigger time point corresponding to one of the key signals, a roll time corresponding to one of the roll signals, and a slide time corresponding to one of the slide signals.

7. The smart control method for an electronic device according to claim 1, wherein the at least one input unit is a touch pad, and the input signals comprise a plurality of point touch signals and a plurality of screen swipe signals.

8. The smart control method for an electronic device according to claim 7, wherein each of the time information comprises a trigger time point corresponding to one of the point touch signals and a screen swipe time corresponding to one of the screen swipe signals.

9. The smart control method for an electronic device according to claim 1, wherein the application is a game application, and in the step of controlling the hardware parameter of the electronic device, a frame refresh rate of a display unit is controlled according to the operating status.

10. The smart control method for an electronic device according to claim 1, wherein the application is a game application, and in the step of controlling the hardware parameter of the electronic device, a resource of a memory and a resource of a graphics processor are allocated according to the operating status.

11. The smart control method for an electronic device according to claim 1, wherein the application is a web browser, and in the step of controlling the hardware parameter of the electronic device, a frame refresh rate of a display unit is controlled according to the operating status.

12. An electronic device, comprising:
an application management unit used to detect an application being executed by the electronic device;
an interception unit used to continuously intercept at least one input unit during a detection period to obtain a plurality of input signals and a plurality of time information corresponding to the input signals;
an identification model used to receive the application, the input signals, and the time information corresponding to the input signals to output an operating status of the application, wherein the operating status comprises a busyness level; and
a control unit used to control the at least one hardware parameter of the electronic device according to the application and the operating status thereof.

13. The electronic device according to claim 12, further comprising:
a display unit;
a memory; and
a graphics processor, wherein the application is a game application, and the control unit controls a frame refresh rate of the display unit according to the operating status or allocates a resource of the memory and a resource of the graphics processor according to the operating status.

14. The electronic device according to claim 12, further comprising:
a display unit, wherein the application is a web browser, and the control unit controls a frame refresh rate of the display unit according to the operating status.

15. The electronic device according to claim 12, wherein the at least one input unit is a keyboard, and the input signals comprise a plurality of key signals.

16. The electronic device according to claim 15, wherein each of the time information comprises a trigger time point corresponding to one of the key signals.

17. The electronic device according to claim 15, wherein each of the time information comprises a press duration corresponding to one of the key signals.

18. The electronic device according to claim 12, wherein the at least one input unit is a mouse, the input signals comprise a plurality of key signals, a plurality of roll signals, and a plurality of slide signals.

19. The electronic device according to claim 18, wherein each of the time information comprises a trigger time point corresponding to one of the key signals, a roll time corresponding to one of the roll signals, and a slide time corresponding to one of the slide signals.

20. The electronic device according to claim 12, wherein the at least one input unit is a touch pad, and the input signals comprise a plurality of point touch signals and a plurality of screen swipe signals.
